(19) United States
(12) Patent Application Publication
(10) Pub. No.: US 2022/0166003 A1
(43) Pub. Date: May 26, 2022

(54) Anode for All-Solid-State Battery Including Coating Layer Containing Magnesium-Based Particles

(71) Applicants: Hyundai Motor Company, Seoul (KR); Kia Corporation, Seoul (KR)

(72) Inventors: Seung Ho Choi, Hanam-si (KR); Sang Heon Lee, Yongin-si (KR); Yun Sung Kim, Seoul (KR)

(73) Assignees: Hyundai Motor Company, Seoul (KR); Kia Corporation, Seoul (KR)

(21) Appl. No.: 17/410,533

(22) Filed: Aug. 24, 2021

(30) Foreign Application Priority Data
Nov. 20, 2020 (KR) 10-2020-0156936

(51) Int. Cl. H01M 4/36; H01M 4/66; H01M 4/587; H01M 4/04; H01M 4/1395; H01M 4/38; H01M 10/0585; H01M 4/134; H01M 10/052

(52) U.S. Cl. CPC H01M 4/364; H01M 4/661; H01M 4/662; H01M 4/587; H01M 4/0404; H01M 2004/027; H01M 4/381; H01M 10/0585; H01M 4/134; H01M 10/052; H01M 4/1395

(57) ABSTRACT

An embodiment anode for an all-solid-state battery includes an anode current collector, and a coating layer on the anode current collector, wherein the coating layer includes a carbon material, and a magnesium-based particle including magnesium, a magnesium compound or a combination thereof. An embodiment all-solid-state battery includes a cathode, an anode including an anode current collector and a coating layer on the anode current collector, the coating layer including a carbon material, and a magnesium-based particle including magnesium, a magnesium compound or a combination thereof, and a solid electrolyte layer between the cathode and the anode, wherein the solid electrolyte layer contacts the coating layer of the anode.

### CROSS-REFERENCE TO RELATED APPLICATIONS

This application claims the benefit of Korean Patent Application No. 10-2020-0156936, filed on Nov. 20, 2020, which application is hereby incorporated herein by reference.

### TECHNICAL FIELD

The present invention relates to an anode for an all-solid-state battery.

### BACKGROUND

Lithium ion batteries are widely used in various devices requiring energy storage. Various battery characteristics such as high energy density, long cycle life, fast charging and discharging, and high- and low-temperature battery operation performance are required depending on the applied field. Recently, the use of fossil fuels has been reduced to solve environmental problems caused by carbon dioxide (CO₂), so electric vehicles using secondary batteries are drawing a great deal of attention in the industry for automobiles, which are a transportation means. A currently developed lithium-ion battery enables travel to a distance of about 400 km on a single charge, but problems such as instability at high temperatures and flammability remain unsolved. In order to solve these problems, many companies are competitively developing next-generation secondary batteries.

The all-solid-state battery is a promising next-generation battery that can replace a conventional lithium ion battery, which uses a flammable liquid electrolyte. A solid electrolyte has a lithium ion mobility coefficient of 1 and thus enables lithium ions to move quickly without interference. In addition, a wide range of high-temperature stability of the solid electrolyte can reduce the risk of fire. However, when a solid electrolyte is introduced into a conventional battery system including a cathode active material and an anode active material including graphite, energy density is reduced by about 40%. Therefore, there is a need for a novel battery system capable of realizing high energy density using a solid electrolyte.

An anodeless all-solid-state battery does not use an anode active material, and thus can achieve high energy density. The anodeless (or anodefree) all-solid-state battery is based on deposition of lithium ions in the form of a lithium metal on an anode current collector. An anodeless all-solid-state battery is largely composed of a cathode/solid electrolyte layer/anode current collector. During charging, lithium ions move from the cathode and are deposited on the anode current collector through a reduction reaction. During discharge, lithium formed between the solid electrolyte layer and the anode current collector is oxidized and returns to the cathode. This process enables repeated charge and discharge without an anode active material.

However, an anodeless all-solid-state battery is actually charged and discharged in a manner different from theory. The solid electrolyte layer and the anode current collector of the anodeless all-solid-state battery cannot form a perfect interface therebetween due to the contact between two solids. The solid electrolyte layer and the anode current collector form a kind of point contact due to the unstable interface therebetween. Lithium ions are locally deposited and/or precipitated (stored) and grown at the point of contact, and the lithium metal penetrates into the solid electrolyte layer. This may cause a short circuit in the all-solid-state battery.

The above information disclosed in this Background section is only for enhancement of understanding of the background of the invention, and therefore it may contain information that does not form the prior art that is already known to a person of ordinary skill in the art.

### SUMMARY

The present invention relates to an anode for an all-solid-state battery. Particular embodiments relate to an anode for an all-solid-state battery including an anode current collector and a coating layer disposed on the anode current collector and containing magnesium-based particles.

Embodiments of the present invention can solve problems associated with the prior art, and an embodiment of the present invention provides an anodeless all-solid-state battery wherein lithium is uniformly deposited between a solid electrolyte layer and an anode current collector during charging.

The embodiments of the present invention are not limited to those described above. Other embodiments of the present invention will be clearly understood from the following description and are able to be implemented by means defined in the claims and combinations thereof.

One embodiment of the present invention provides an anode for an all-solid-state battery including an anode current collector, and a coating layer disposed on the anode current collector, wherein the coating layer includes a carbon material and a magnesium-based particle including magnesium, a magnesium compound or a combination thereof.

The anode current collector may include nickel (Ni), stainless steel (SUS) or a combination thereof.

The magnesium compound may include MgO, MgS, MgF₂, Mg₃N₂ or a combination thereof.

The magnesium-based particle may have a particle size (D₅₀) of 10 nm to 2,000 nm.

The coating layer may have a thickness of 0.1 μm to 20 μm.

The coating layer may include 10% to 70% by weight of the carbon material and 30% to 90% by weight of the magnesium-based particle.

A charge product containing lithium may be formed between the coating layer and the anode current collector when an all-solid-state battery is charged.

Another embodiment of the present invention provides an all-solid-state battery including a cathode, the anode described above and a solid electrolyte layer disposed between the cathode and the anode, wherein the solid electrolyte layer is stacked such that the solid electrolyte layer contacts a coating layer of the anode.

Another embodiment of the present invention provides a method of producing an anode for an all-solid-state battery including preparing a slurry comprising a carbon material, a magnesium-based particle containing magnesium, a magnesium compound or a combination thereof, and a binder, and applying the slurry to an anode current collector to form a coating layer.

The slurry may be prepared by adding the carbon material, the magnesium-based particle and the binder to a solvent.

The slurry may be prepared by adding the binder in an amount of 1 to 30 parts by weight based on 100 parts by weight of the total of the carbon material and the magnesium-based particle.

Other aspects and preferred embodiments of the invention are discussed infra.

### BRIEF DESCRIPTION OF THE DRAWINGS

The above and other features of the present invention will now be described in detail with reference to certain exemplary embodiments thereof, illustrated in the accompanying drawings which are given hereinbelow by way of illustration only, and thus are not limitative of the present invention, and wherein:

FIG. 1 is a cross-sectional view showing an all-solid-state battery according to embodiments of the present invention;

FIG. 2 is a cross-sectional view showing the state in which an all-solid-state battery according to embodiments of the present invention is charged;

FIG. 3A shows a result of scanning electron microscope (SEM) analysis of the surface of a coating layer produced in Example 1;

FIG. 3B shows a result of analysis of the surface of the coating layer produced in Example 1 at a higher magnification compared to FIG. 3A;

FIG. 4A shows a result of evaluation of the performance of a half cell according to Comparative Example 1;

FIG. 4B shows a result of evaluation of the performance of a half cell according to Comparative Example 2;

FIG. 4C shows a result of evaluation of the performance of a half cell according to Example 1;

FIG. 4D shows a result of evaluation of the performance of a half cell according to Example 2;

FIG. 5A shows a result of scanning electron microscope (SEM) analysis of the cross section of a charged half-cell according to Example 1;

FIG. 5B shows a result of energy dispersive X-ray analysis (EDS) of carbon (C) in the cross section of a charged half-cell according to Example 1; and

FIG. 5C shows a result of energy dispersive X-ray analysis (EDS) of magnesium (Mg) in the cross section of a charged half-cell according to Example 1.

### DETAILED DESCRIPTION OF ILLUSTRATIVE EMBODIMENTS

The features described above, as well as other objects, features and advantages, will be clearly understood from the following preferred embodiments with reference to the attached drawings. However, the present invention is not limited to the embodiments, and may be embodied in different forms. The embodiments are suggested only to offer a thorough and complete understanding of the disclosed context and to sufficiently inform those skilled in the art of the technical concept of the present invention.

Like reference numbers refer to like elements throughout the description of the figures. In the drawings, the sizes of structures may be exaggerated for clarity. It will be understood that, although the terms “first”, “second”, etc. may be used herein to describe various elements, these elements should not be construed as being limited by these terms, which are used only to distinguish one element from another. For example, within the scope defined by embodiments of the present invention, a “first” element may be referred to as a “second” element, and similarly, a “second” element may be referred to as a “first” element. Singular forms are intended to include plural forms as well, unless the context clearly indicates otherwise.

It will be further understood that the terms “comprises” and/or “has”, when used in this specification, specify the presence of stated features, integers, steps, operations, elements, components or combinations thereof, but do not preclude the presence or addition of one or more other features, integers, steps, operations, elements, components, or combinations thereof. In addition, it will be understood that, when an element such as a layer, film, region or substrate is referred to as being “on” another element, it can be directly on the other element, or an intervening element may also be present. It will also be understood that when an element such as a layer, film, region or substrate is referred to as being “under” another element, it can be directly under the other element, or an intervening element may also be present.

Unless the context clearly indicates otherwise, all numbers, figures and/or expressions that represent ingredients, reaction conditions, polymer compositions and amounts of mixtures used in the specification are approximations that reflect various uncertainties of measurement occurring inherently in obtaining these figures, among other things. For this reason, it should be understood that, in all cases, the term “about” should be understood to modify all numbers, figures and/or expressions. In addition, when numerical ranges are disclosed in the description, these ranges are continuous, and include all numbers from the minimum to the maximum, including the maximum within each range, unless otherwise defined. Furthermore, when the range refers to an integer, it includes all integers from the minimum to the maximum including the maximum within the range, unless otherwise defined.

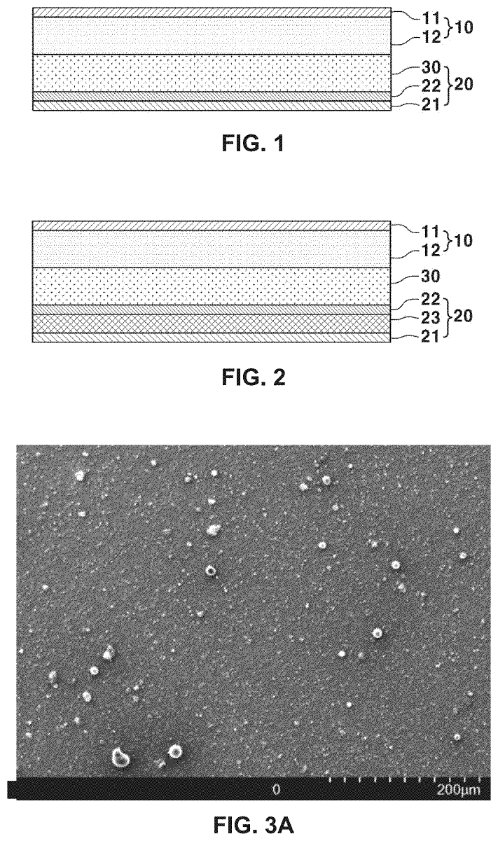

FIG. 1 is a cross-sectional view showing an all-solid-state battery according to embodiments of the present invention. Referring to FIG. 1, the all-solid-state battery includes a cathode 10 including a cathode current collector ii and a cathode active material layer 12, an anode 20 including an anode current collector 21 and a coating layer 22, and a solid electrolyte layer 30 disposed between the cathode 10 and the anode 20. In this case, the coating layer 22 and the solid electrolyte layer 30 are stacked such that they come into contact with each other.

The cathode current collector 11 may be a plate-shaped substrate having electrical conductivity. The cathode current collector 11 may include an aluminum foil.

The cathode active material layer 12 may include a cathode active material, a solid electrolyte, a conductive material, a binder and the like.

The cathode active material may be an oxide active material or a sulfide active material.

The oxide active material may be a rock-salt-layer-type active material such as LiCoO₂, LiMnO₂, LiNiO₂, LiVO₂, or Li₁₊ₓNi_{1/3}Co_{1/3}Mn_{1/3}O₂, a spinel-type active material such as LiMn₂O₄ or Li(Ni_{0.5}Mn_{1.5})O₄, a reverse-spinel-type active material such as LiNiVO₄ or LiCoVO₄, an olivine-type active material such as LiFePO₄, LiMnPO₄, LiCoPO₄, or LiNiPO₄, a silicon-containing active material such as Li₂FeSiO₄ or Li₂MnSiO₄, a rock-salt-layer-type active material having a transition metal, a part of which is substituted with a heterogeneous metal such as LiNi_{0.8}Co_{(0.2-x)}Al₂O₂ (0<x<0.2), a spinel-type active material having a transition metal, a part of which is substituted with a heterogeneous metal such as Li₁₊ₓMn_{2-x-y}M_{y}O₄ (wherein M includes at least one of Al, Mg, Co, Fe, Ni, or Zn, and 0<x+y<2), and lithium titanate such as Li₄Ti₅O₁₂.

The sulfide active material may be copper Chevrel, iron sulfide, cobalt sulfide, nickel sulfide, or the like.

The solid electrolyte may be an oxide solid electrolyte or a sulfide solid electrolyte. However, preferred is the use of a sulfide solid electrolyte having high lithium ion conductivity. The sulfide solid electrolyte is not particularly limited, but may be Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅ZₘSₙ (wherein m and n are positive numbers and Z is Ge, Zn or Ga), Li₂S—GeS₂, Li₂S—SiS₂—Li₃PO₄, Li₂S—SiS₂—LiₓMO_{y} (wherein x and y are positive numbers and M is P, Si, Ge, B, Al, Ga, or In), Li₁₀GeP₂S₁₂ or the like.

The conductive material may be carbon black, conductive graphite, ethylene black, graphene, or the like.

The binder may be butadiene rubber (BR), nitrile butadiene rubber (NBR), hydrogenated nitrile butadiene rubber (HNBR), polyvinylidene difluoride (PVDF), polytetrafluoroethylene (PTFE), carboxymethylcellulose (CMC), or the like, and may be the same as or different from the binder included in the anode 20.

The solid electrolyte layer 30 is interposed between the cathode 10 and the anode 20 to allow lithium ions to move between the two elements.

The solid electrolyte layer 30 may include an oxide solid electrolyte or a sulfide solid electrolyte. However, preferred is the use of a sulfide solid electrolyte having high lithium ion conductivity. The sulfide solid electrolyte is not particularly limited, but may be Li₂S—P₂S₅, Li₂S—P₂5₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂13 LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (wherein m and n are positive numbers and Z is Ge, Zn, or Ga), Li₂S—GeS₂, Li₂S—SiS₂—Li₃PO₄, Li₂S—SiS₂—LiₓMO_{y} (wherein x and y are positive numbers and M is P, Si, Ge, B, Al, Ga, or In), Li₁₀GeP₂S₁₂ or the like.

The anode 20 includes an anode current collector 21 and a coating layer 22 disposed on the anode current collector 21.

The anode current collector 21 may be a plate-shaped substrate having electrical conductivity. The anode current collector 21 may include nickel (Ni), stainless steel (SUS), or a combination thereof.

The anode current collector 21 may be a high-density metal thin film having porosity of less than about 1%.

The anode current collector 21 may have a thickness of 1 μm to 20 μm, or 5 μm to 15 μm.

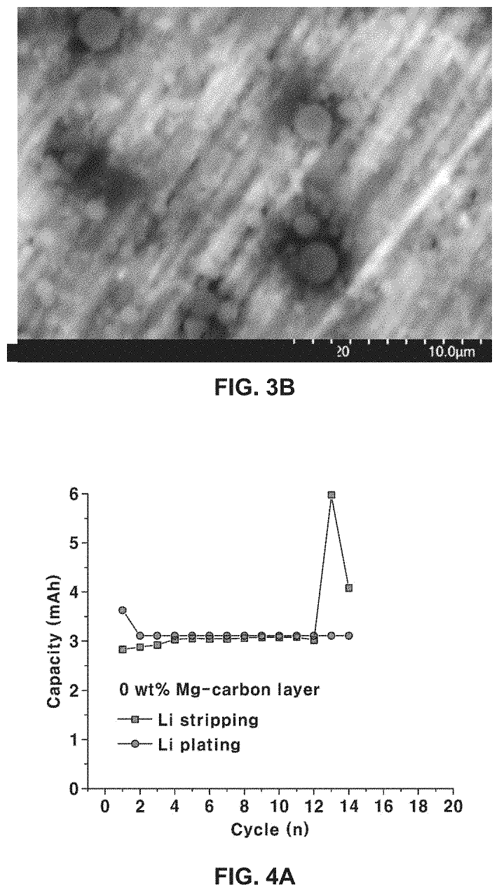

The coating layer 22 causes lithium ions that have moved from the cathode 10 during charging of the all-solid-state battery as shown in FIG. 2 to uniformly precipitate a charge product 23 on the anode current collector 21.

The coating layer 22 may include a carbon material and magnesium-based particles.

The carbon material may include a particulate carbon material, a fibrous carbon material, a graphene, or a combination thereof.

The particulate carbon material may include carbon black, graphitizable carbon, non-graphitizable carbon, or a combination thereof. The particulate carbon material may have a particle diameter of 10 nm to 200 nm.

In addition, the fibrous carbon material may include carbon nanofibers, carbon nanotubes, vapor-grown carbon fibers, or a combination thereof. The fibrous carbon material may have a fibrous cross-sectional diameter of 10 nm to 200 nm.

The magnesium-based particles may include a material which may react with lithium ions to form an alloy or a compound. Specifically, the magnesium-based particles may include magnesium (Mg), a magnesium compound, or a combination thereof.

The magnesium compound may include MgO, MgS, MgF₂, Mg₃N₂ or a combination thereof.

Magnesium (Mg) is eco-friendly and inexpensive owing to the abundant stores thereof. By using magnesium-based particles, an all-solid-state battery that is environmentally friendly and has high price competitiveness can be implemented.

The magnesium-based particles may have a particle size (D₅₀) of 10 nm to 2,000 nm. When the particle size (D₅₀) of the magnesium-based particles is less than 10 nm, there may be a problem in that the surface of the particles is oxidized, and when the particle size (D₅₀) exceeds 2,000 nm, there may be a problem in which the magnesium-based particles do not react with lithium.

The coating layer 22 may have a thickness of 0.1 μm to 20 μm. When the thickness of the coating layer 22 is less than 0.1 μm, there may be a problem in that the electrode is unstable during processing, and when the thickness exceeds 20 μm, there may be a problem in that the cell energy density is deteriorated.

The coating layer 22 may include 10% to 70% by weight of the carbon material and 30% to 90% by weight of the magnesium-based particles. When the content of the magnesium-based particles is less than 30% by weight, the charge product 23 may not grow uniformly.

The method of producing an anode for an all-solid-state battery includes preparing a slurry containing the carbon material, the magnesium based-particles and a binder, and applying the slurry to an anode current collector to form a coating layer.

The carbon material and the magnesium-based particles have been described above, and detailed descriptions thereof will be omitted below.

The slurry may be prepared by adding the carbon material, the magnesium-based particles and the binder to a solvent.

The binder is not particularly limited and may include, for example, polyvinylidene difluoride (PVDF), carboxymethylcellulose (CMC), polyethylene oxide (PEO) and the like.

The binder may be added in an amount of 1 to 30 parts by weight based on 100 parts by weight of the total of the carbon material and the magnesium-based particles.

The solvent may include an organic solvent such as n-methyl-2-pyrrolidone (NMP), ethanol or isopropanol, or an aqueous solvent such as water.

The method of applying the slurry is not particularly limited, and the slurry may be applied by a method such as doctor blade casting or spray coating.

After applying the slurry, the coating layer may be formed by removing the solvent through drying or heat treatment.

Hereinafter, embodiments of the present invention will be described in more detail with reference to specific examples. However, the following examples are provided only for better understanding of embodiments of the present invention, and thus should not be construed as limiting the scope of the present invention.

### EXAMPLE 1

A carbon material, a magnesium powder and PVDF were added to NMP as a solvent to prepare a slurry. At this time, the content of the carbon material was adjusted to 30% by weight and the content of the magnesium powder was adjusted to 70% by weight, based on the total amount of the carbon material and the magnesium powder.

The slurry was applied to a nickel thin film as an anode current collector, followed by drying, to form a coating layer.

Nickel (Ni) is suitable as a current collector because it is electrochemically nonreactive with the electrolyte. However, nickel is electrochemically nonreactive with lithium, thus causing a problem of difficulty in uniformly depositing a charge product containing lithium. In this example, a half-cell having a lithium/solid-electrolyte/coating-layer/cathode-current-collector structure was produced by applying a coating layer containing a magnesium powder.

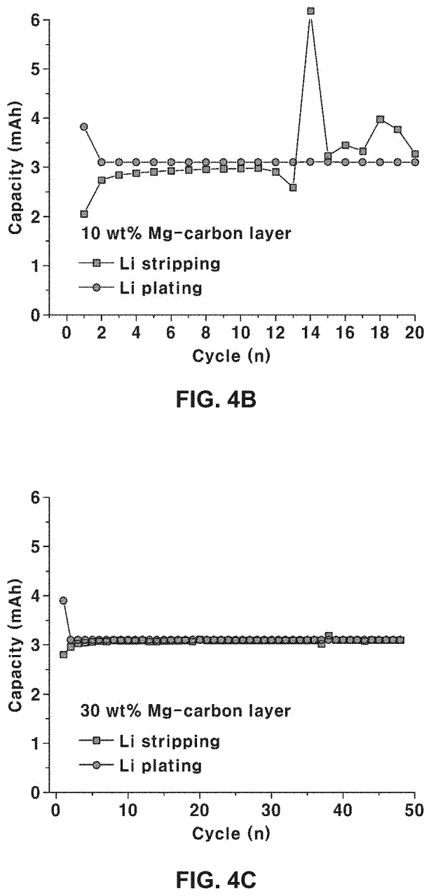

FIG. 3A shows a result of scanning electron microscope (SEM) analysis of the surface of the coating layer produced in Example 1. FIG. 3B shows a result of analysis at a higher magnification compared to FIG. 3A. As can be seen from FIGS. 3A and 3B, magnesium having a particle size (D₅₀) of about 100 nm is distributed.

### EXAMPLE 2

A half-cell was produced in the same manner as in Example 1, except that the content of the carbon material was adjusted to 50% by weight and the content of the magnesium powder was adjusted to 50% by weight.

### COMPARATIVE EXAMPLE 1

A half-cell was produced in the same manner as in Example 1, except that the content of the carbon material was adjusted to 100% by weight and the content of the magnesium powder was adjusted to 0% by weight.

### COMPARATIVE EXAMPLE 2

A half-cell was produced in the same manner as in Example 1, except that the content of the carbon material was adjusted to 90% by weight and the content of the magnesium powder was adjusted to 10% by weight.

### EXPERIMENTAL EXAMPLE 1

The half cells of Example 1, Example 2, Comparative Example 1 and Comparative Example 2 were repeatedly charged and discharged, and the performance thereof was evaluated. The performance evaluation was carried out by fixing a current density at 1.175 mA/cm² and a deposition capacity at 2.35 mAh/cm². Specifically, lithium ions were constantly stored at a capacity of 2.35 mA/cm² through a charging process, and the performance thereof was evaluated by determining to what extent the deposited lithium reversibly returns through a discharging process.

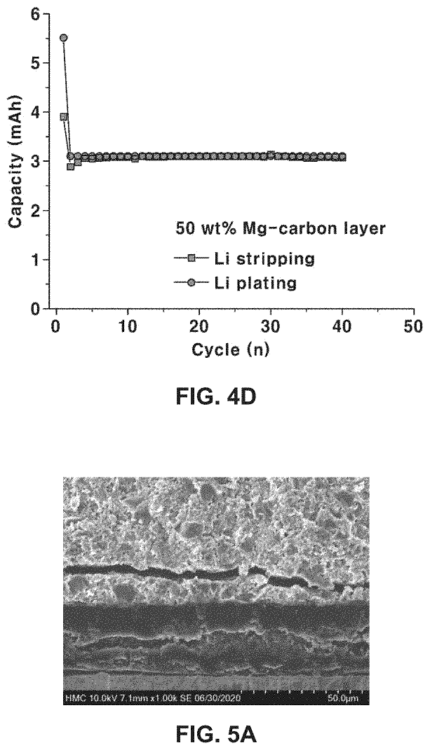

FIGS. 4A, 4B, 4C and 4D show the results of performance evaluation of Comparative Example 1, Comparative Example 2, Example 1, and Example 2, respectively.

Referring to FIG. 4A, in Comparative Example 1 provided with a coating layer made of carbon material without magnesium powder, the cell was short-circuited when overcharged during the 12th cycle. Referring to FIG. 4B, Comparative Example 2, provided with a coating layer containing 10% by weight of a magnesium powder, also had an overcharge problem after 10 cycles.

Referring to FIGS. 4C and 4D, in the all-solid-state battery provided with a coating layer containing 30% to 50% by weight of the magnesium powder as in embodiments of the present invention, the cell was stably driven for 30 cycles or more, and had an efficiency per cycle of 99% or more.

### EXPERIMENTAL EXAMPLE 2

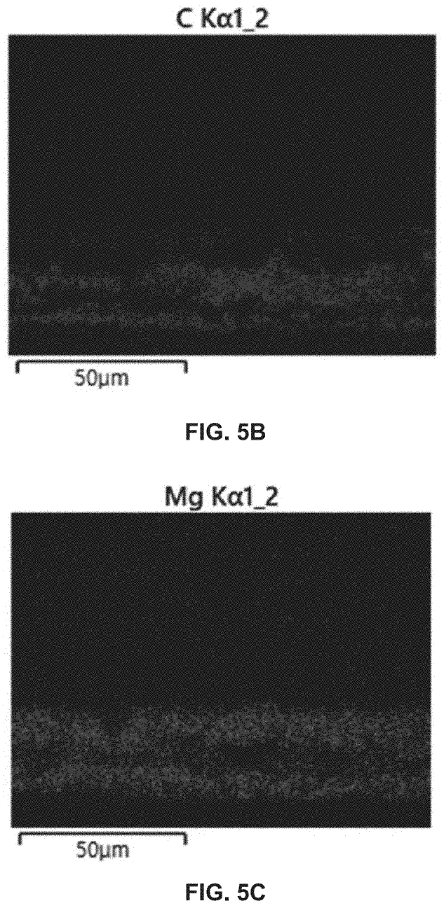

FIG. 5A shows a result of scanning electron microscope (SEM) analysis of the cross section of a charged half-cell according to Example 1. As can be seen from FIG. 5A, the charge product is evenly formed under the coating layer.

FIG. 5B shows a result of energy dispersive X-ray analysis (EDS) of carbon (C) in the cross section of a charged half-cell according to Example 1. In addition, FIG. 5C shows a result of energy dispersive X-ray analysis (EDS) of magnesium (Mg) in the cross section of a charged half-cell according to Example 1. As can be seen from FIGS. 5B and 5C, the carbon (C) and magnesium (Mg) are evenly formed under the coating layer.

As is apparent from the foregoing, embodiments of the present invention provide an anodeless all-solid-state battery that is capable of stably repeating charge and discharge since lithium is uniformly deposited between the solid electrolyte layer and the anode current collector during charging.

The effects of embodiments of the present invention are not limited to those mentioned above. It should be understood that the effects of embodiments of the present invention include all effects that can be inferred from the description of the embodiments of the present invention.

The present invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. An anode for an all-solid-state battery, the anode comprising:
an anode current collector; and
a coating layer on the anode current collector, wherein the coating layer comprises:
a carbon material; and
a magnesium-based particle including magnesium, a magnesium compound or a combination thereof.

2. The anode according to claim 1, wherein the anode current collector comprises nickel (Ni), stainless steel (SUS) or a combination thereof.

3. The anode according to claim 1, wherein the magnesium-based particle comprises MgO, MgS, MgF₂, Mg₃N₂ or a combination thereof.

4. The anode according to claim 1, wherein the magnesium-based particle has a particle size (D₅₀) of 10 nm to 2,000 nm.

5. The anode according to claim 1, wherein the coating layer has a thickness of 0.1 μm to 20 μm.

6. The anode according to claim 1, wherein the coating layer comprises:
10% to 70% by weight of the carbon material; and
30% to 90% by weight of the magnesium-based particle.

7. The anode according to claim 1, further comprising a charge product containing lithium between the coating layer and the anode current collector when the all-solid-state battery is charged.

8. An all-solid-state battery comprising:
a cathode;
an anode comprising an anode current collector and a coating layer on the anode current collector, wherein the coating layer comprises:
a carbon material; and
a magnesium-based particle including magnesium, a magnesium compound or a combination thereof; and
a solid electrolyte layer between the cathode and the anode, wherein the solid electrolyte layer contacts the coating layer of the anode.

9. The all-solid-state battery according to claim 8, wherein the anode current collector comprises nickel (Ni), stainless steel (SUS) or a combination thereof.

10. The all-solid-state battery according to claim 8, wherein:
the magnesium-based particle comprises MgO, MgS, MgF₂, Mg₃N₂ or a combination thereof; and
the magnesium-based particle has a particle size (D₅₀) of 10 nm to 2,000 nm.

11. The all-solid-state battery according to claim 8, wherein the coating layer has a thickness of 0.1 μm to 20 μm, and wherein the coating layer comprises:
10% to 70% by weight of the carbon material; and
30% to 90% by weight of the magnesium-based particle.

12. The all-solid-state battery according to claim 8, further comprising a charge product containing lithium between the coating layer and the anode current collector when the all-solid-state battery is charged.

13. A method of producing an anode for an all-solid-state battery, the method comprising:
preparing a slurry comprising a carbon material, a magnesium-based particle comprising magnesium, a magnesium compound or a combination thereof, and a binder; and
applying the slurry to an anode current collector to form a coating layer.

14. The method according to claim 13, wherein preparing the slurry comprises adding the carbon material, the magnesium-based particle and the binder to a solvent.

15. The method according to claim 13, wherein preparing the slurry comprises adding the binder in an amount of 1 to 30 parts by weight based on 100 parts by weight of the total of the carbon material and the magnesium-based particle.

16. The method according to claim 13, wherein the magnesium-based particle comprises MgO, MgS, MgF₂, Mg₃N₂ or a combination thereof.

17. The method according to claim 13, wherein the magnesium-based particle has a particle size (D₅₀) of 10 nm to 2,000 nm.

18. The method according to claim 13, wherein the coating layer has a thickness of 0.1 μm to 20 μm.

19. The method according to claim 13, wherein the coating layer comprises:
10% to 70% by weight of the carbon material; and
30% to 90% by weight of the magnesium-based particle.

20. The method according to claim 13, further comprising:
charging the all-solid-state battery; and
forming a charge product containing lithium between the coating layer and the anode current collector as a result of the charging.
